(19) United States
(12) Patent Application Publication
(10) Pub. No.: US 2006/0107860 A1
(43) Pub. Date: May 25, 2006

(54) Press control desk

(76) Inventor: Peer Dilling, Friedberg (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/267,350

(22) Filed: Nov. 4, 2005

(30) Foreign Application Priority Data
Nov. 6, 2004 (DE) 10 2004 053 738.0

(51) Int. Cl. B41F 33/00

(52) U.S. Cl. 101/484

(57) ABSTRACT

A press control desk, having a combined display and operating device is disclosed. The device, firstly, is used for the display of objects, in particular press states and/or press functional elements and/or press operating elements, and secondly, is used for the input of commands and/or operators for a press control system. The device has a plate-like or pane-like projection element forming a projection plane, on which the objects to be displayed, in particular the press states and/or press functional elements and/or press operating elements, can be visualized via a projector by using back projection. The device also has a monitoring device which registers a relative position between the projection element and an input element in order to register commands and/or operators to be input via the input element, and transmits them to the press control system.

This application claims the priority of German Patent Document No. 10 2004 053 738.0, filed Nov. 6, 2004, the disclosure of which is expressly incorporated by reference herein.

### BACKGROUND AND SUMMARY OF THE INVENTION

The invention relates to a press control desk.

Control desks known from the prior art for presses have at least one display device for visualizing objects such as press states and/or press functional elements and also at least one operating device for the input of commands and/or operators for the press control system. According to the prior art, the display devices are separate from the operating devices and designed as separate subassemblies, although touch screen applications are also already known. The display devices are normally screens or monitors, the operating devices are keyboards or other operating devices designed using hardware, such as switches or knobs. Since, in particular, web-fed presses differ highly from one another, depending on the configuration ordered by the customer, the press control desks according to the prior art of the presses and their population differ considerably from one another. It follows directly from this that, according to the prior art, depending on a configuration of the press ordered by the customer, an individually adapted press control desk is designed using hardware and software. As a result, it is as good as impossible to standardize the construction of press control desks. If the functionality of such press control desks known from the prior art is to be expanded, then it is generally necessary to install additional display devices and/or additional operating devices on the press control desk. The expansion of an existing press control desk by adding additional display devices and operating devices is disadvantageous for cost reasons and also ergonomic reasons. For example, the ease of operation of a press control desk suffers under the addition of additional display devices and operating devices to an existing press control desk. Furthermore, the costs for the press control desk are increased as a result.

From this starting point, the present invention is based on the problem of providing a novel type of press control desk.

The press control desk according to the invention has a combined display and operating device which, firstly, is used for the display of objects, in particular press states and/or press functional elements and/or press operating elements, and which, secondly, is used for the input of commands and/or operators for a press control system, the display and operating device having a plate-like or pane-like projection element forming a projection plane, on which the objects to be displayed, in particular the press states and/or press functional elements and/or press operating elements, can be visualized via a projector by using back projection, and the display and operating device also having a monitoring device which registers a relative position between the projection element and an input element in order to register commands and/or operators to be input via the input element, and transmits them to the press control system.

The press control desk according to the invention is distinguished by a combined display and operating device. The combined display and operating device has the projection element forming the projection plane, on which the objects to be displayed can be visualized with the aid of back projection. For example, the projection element can be broken down by software into regions which are used for the simple display of press states and/or press functional elements or which, on the other hand, are used for the display of press operating elements and for the input of the commands and/or operators in the region of the press control elements. With the aid of the monitoring device, the relative position between the input element and the projection element can be determined, it being possible for commands and/or operators to be determined from the relative position between the input element and the projection element.

By means of the press control desk according to the invention, it becomes possible to standardize the construction of press control desks. The functionality of a press control desk can be expanded or changed by simply changing the software. Configuration changes of the hardware are no longer necessary in order to expand the functionality of a press control desk. This results in ergonomic advantages and cost advantages. The press control desk according to the invention provides a user interface which can be expanded or changed simply.

### BRIEF DESCRIPTION OF THE DRAWINGS

Preferred developments of the invention emerge from the following description. An exemplary embodiment of the invention will be explained in more detail by using the drawings, without being restricted thereto.

FIG. 1 shows a schematic side view of the press control desk according to the invention.

FIG. 2 shows a further schematic view of the press control desk according to the invention from FIG. 1.

FIG. 3 shows a schematic side view of an alternative press control desk according to the invention.

FIG. 4 shows a schematic plan view of a projection element forming a projection plane of the press control desk according to the invention.

FIG. 5 shows a further schematic plan view of the projection element of FIG. 4 with a monitoring device.

### DETAILED DESCRIPTION OF THE DRAWINGS

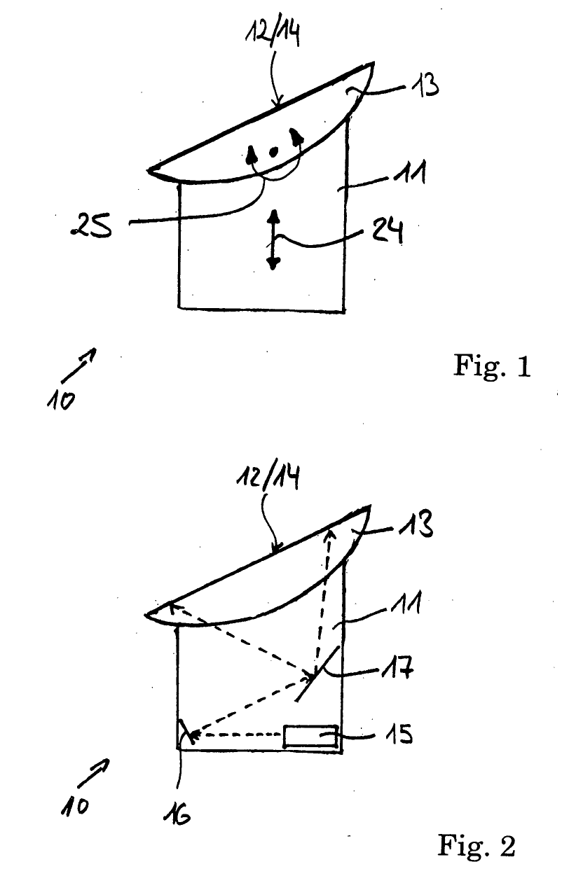

In the following text, the present invention will be described in greater detail with reference to FIGS. 1 to 5.

FIGS. 1 and 2 show a first exemplary embodiment of a press control desk 10 according to the invention, the press control desk 10 having a combined display and operating device 11. The combined display and operating device 11 is used firstly to display objects such as press states and/or press functional elements and/or press operating elements and secondly to input commands and/or operators for the press control system.

The combined display and operating device 11 has a plate-like or pane-like projection element 13 forming a projection plane 12. The projection plane 12 of the projection element 13 is formed by a surface 14 of the same. On the surface 14 or the projection plane 12 of the projection element 13, the objects to be displayed can be visualized via a projector 15 by using back projection. As can be gathered from FIG. 2, for this purpose the projector 15 interacts with a plurality of mirrors 16 and 17, which ultimately project the objects to be displayed onto the surface 14 of the projection plane 12 of the projection element 13.

FIG. 4 shows a plan view of the surface 14 or projection plane 12 of the projection element 13, the surface 14 or projection plane 12 of the projection element 13 being subdivided into a total of five regions in the exemplary embodiment of FIG. 4. A first region 18 is used for the display of press states, a second region 19 is used for the display of press functional elements, and the regions 20 are used for the display of press operating elements. It should be pointed out at this juncture that the regions 18, 19 and 20 can be defined freely by software. Thus, for example, the number of regions 20 for the display of press operating elements can be changed via a simple software change. In this way, the functionality of the display and operating device 11 can be expanded simply.

The regions 18 and 19 are used exclusively for the display of objects, specifically for the display of press states and press functional elements. The regions 20, on the other hand, are used firstly for the display of press operating elements and secondly for the input of commands and/or operators, a relative position between the projection element 13 and an input element, not shown, being registered by a monitoring device for this purpose. From a relative position between the projection element and the input element, it is possible to draw conclusions about a command and/or operator to be input, which is then transmitted automatically to a press control system.

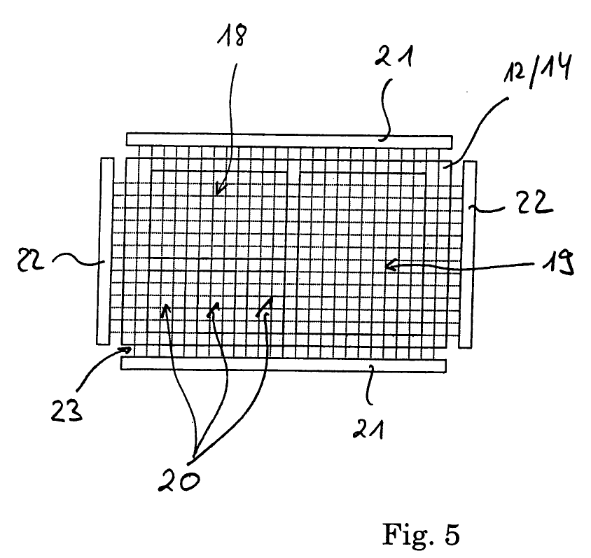

The input element, not shown, for the input of commands and/or operators in the regions 20 in which press operating elements can be visualized can be formed, for example, as an input pen. The monitoring device for monitoring the relative position between the input element and the surface 14 or projection plane 12 of the projection element 13 can, for example, as shown in FIG. 5, be formed by two light barrier devices 21 and 22. The light barrier devices 21 and 22 produce a light barrier array 23 visualized by dotted lines, the light barrier array 23 being interrupted at a position of the array when an input element comes into the region of the surface 14 or projection plane 12. For instance, if the input element is moved into one of the regions 20 which are used for the visualization of a press operating element, then it can be concluded from this that the press operating element which is visualized in this region 20 is to be actuated. Accordingly, from the relative position between the input element and the projection plane 12 of the projection element 13 it is possible to conclude whether and which command or operator for a press control system is intended to be input. On the other hand, if the input element is located in the region 19, for example, which is used exclusively for the display of press states, then it can be concluded from this that no command or operator is intended to be input.

It should be pointed out that the configuration of the monitoring device with the aid of the light barrier devices 21 and 22 merely represents one possibility. Thus, it is also possible to monitor the relative position between the projection element 13 or the projection surface 12 of the same and the input element via two cameras, which are positioned above the projection element 13. Likewise, the actual configuration of the input element which is moved relative to the projection surface 12 of the projection element 13 in order to input operators or commands can be changed to the effect that, for example, a computer mouse is used. In addition, in the exemplary embodiment of FIG. 5, an operator can use a finger as an input element.

In order to increase the ergonomic nature of the press control desk 10 according to the invention, the projection element 13 is designed such that its position relative to an operator can be adjusted. For this purpose, the projection element 13 can be adjusted vertically in the direction of the arrow 24 and pivoted in the direction of the arrow 25. In this way, a viewing angle onto the projection surface 12 of the projection element 13 can be matched optimally to the respective operator.

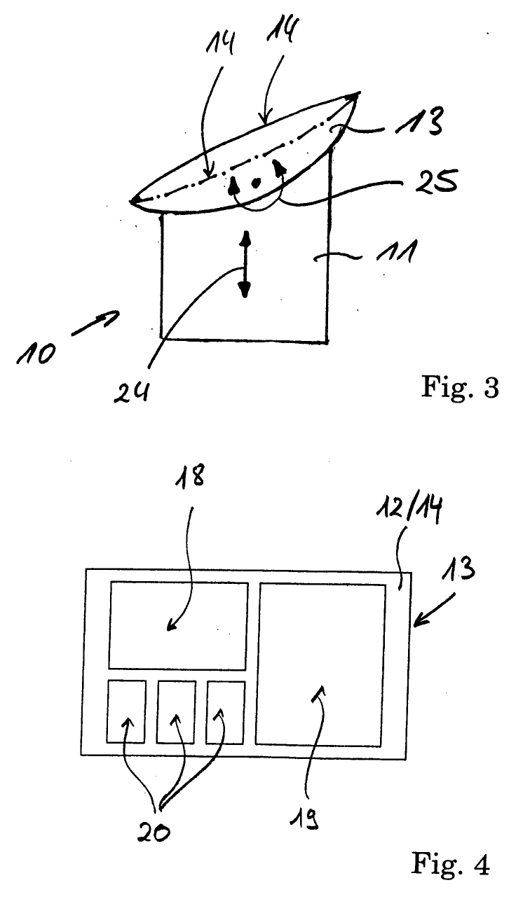

In the exemplary embodiment of FIGS. 1 and 2, the surface 14 or the projection plane 12 of the projection element 13 is designed to be flat. As FIG. 3 shows, the surface of the projection element 13 can also be curved concavely or curved convexly. FIG. 3 shows, by using continuous lines, a convexly curved surface 14 of the projection element 13, a concavely curved surface 14 of the projection element 13 is shown by dash-dotted lines. By means of an appropriate curvature of the surface 14 or projection plane 12 of the projection element 13, the legibility of the same can be improved.

Via the projection and display of the press states and/or press functional elements and/or press operating elements on the surface of the projection element, a user interface which can be configured by software is produced on a press control desk. This results in great flexibility, since the user interface or the press control desk can be reconfigured and expanded by simply changing the software. The press control desk according to the invention can accordingly be designed identically for all press configurations, so that the depth of fabrication for press control desks can be reduced considerably as compared with the prior art. In this way, production costs can be lowered.

In conclusion, it should be pointed out that the press control desk 10 according to the invention can have, in addition to the display and operating device 11, an assessment table for printed copies, which is preferably positioned at the side beside the display and operating device 11. An operator of the press places printed copies on the assessment table for the purpose of visual inspection.

List of reference symbols:
10 Press control desk
11 Display and operating device
12 Projection plane
13 Projection element
14 Surface
15 Projector
16 Mirror
17 Mirror
18 Region
19 Region
20 Region
21 Light barrier device
22 Light barrier device
23 Light barrier array
24 Direction of movement
25 Direction of movement

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A press control desk, having a combined display and operating device which, firstly, is used for display of objects, in particular press states and/or press functional elements and/or press operating elements, and which, secondly, is used for input of commands and/or operators for a press control system, the display and operating device having a plate-like or pane-like projection element forming a projection plane, on which objects to be displayed, in particular the press states and/or press functional elements and/or press operating elements, are visualized via a projector by using back projection, and the display and operating device also having a monitoring device which registers a relative position between the projection element and an input element in order to register commands and/or operators to be input via the input element, and transmits the commands and/or operators to the press control system.

2. The press control desk according to claim 1, wherein a position of the projection element relative to an operator is adjustable.

3. The press control desk according to claim 2, wherein the projection element is adjustable vertically and pivotally.

4. The press control desk according to claim 1, wherein the projection element has a convexly curved surface or a concavely curved surface.

5. The press control desk according to claim 1, wherein a functionality of the projection element as a user interface is definable and configurable by software.

6. The press control desk according to claim 5, wherein a region of the projection element which is used exclusively for the display of press states and/or press functional elements is definable and configurable by software.

7. The press control desk according to claim 5, wherein a region of the projection element which is used for the display of press operating elements and for the input of commands and/or operators in a region of the visualized press operating elements is definable and configurable by software.

8. The press control desk according to claim 1, wherein the monitoring device has at least two light barrier devices forming a light barrier array, which determines the relative position between the projection element and the input element in order to register commands and/or operators input via the input element.

9. The press control desk according to claim 1, wherein the monitoring device has at least two cameras, which determine the relative position between the projection element and the input element in order to register commands and/or operators input via the input element.

10. A press control desk, comprising:
a combined display and operating device, wherein the device displays an object and inputs a command for a press control system, and includes:
a projection element forming a projection plane on which the object is visualized; and
a monitoring device which registers a relative position between the projection element and an input element.

11. A method for operating a press control desk, comprising the steps of:
configuring a plurality of regions on a projection element by software;
monitoring a relative position between an input device and the plurality of regions; and
determining whether a command is input to a press control system based on the relative position.
